(19) United States
(12) Patent Application Publication
(10) Pub. No.: US 2008/0028246 A1
(43) Pub. Date: Jan. 31, 2008

(54) Self-monitoring and self-adjusting power consumption computer control system

(76) Inventor: Timothy Dean Witham, Aloha, OR (US)

Correspondence Address: JOHN BRUCKNER, P.C., P.O. BOX 490, FLAGSTAFF, AZ, 86002, US

(21) Appl. No.: 11/888,030

(22) Filed: Jul. 30, 2007

Related U.S. Application Data
(60) Provisional application No. 60/834,677, filed on Jul. 31, 2006.

(51) Int. Cl. G06F 1/26

(52) U.S. Cl. 713/330

(57) ABSTRACT

Methods and apparatus are described for self-monitoring and self-adjusting power consumption computer control system. A method includes measuring power consumption of a variable power requirement load by a power monitor; and controlling power requirement of the variable power requirement load by sending from the power monitor i) a down_power interrupt to enable one at a time a plurality of power saving features and ii) an up_power interrupt to disable one at a time a plurality of power saving features. The down_power interrupt is generated by the power monitor in response to a high_trip interrupt that is generated in response to measured power consumption being greater than or equal to an upper threshold, unless there has been a previous enablement of all of the plurality of power saving features. The up_power interrupt is generated by the power monitors in response to a low_trip interrupt that is generated in response to measured power consumption being less than or equal to a lower threshold, unless a mask_up bit has been written by a previous disablement of all of the plurality of power saving features.

### CROSS-REFERENCE TO RELATED APPLICATION

This application claims a benefit of priority under 35 U.S.C. 119(e) from copending provisional patent application U.S. Ser. No. 60/834,677, filed Jul. 31, 2006, the entire contents of which are hereby expressly incorporated herein by reference for all purposes.

### BACKGROUND INFORMATION

1. Field of the Invention

Embodiments of the invention relate generally to the field of computer systems and more specifically relate to power management for computer systems. More particularly, an embodiment of the invention relates to methods of and machinery for self-monitoring and self-adjusting power consumption computer control system.

2. Discussion of the Related Art

The availability and cost of electrical power have become critical questions in the operation of current, large-scale, microprocessor based systems. Maximum power consumption increases with the size and complexity of the systems. As the systems grow larger, management of power consumption grows more complex. For users of the systems, actual power consumption depends upon many factors. Some of these factors are predictable over a range of conditions based upon the type and number of components in the design and clock speeds. There are additional key factors. In most modern computer systems, the demands for power also depend upon how the computer system is being used. The range of use is wide, as is the range of power required. It varies with the number and size of the programs being executed, and even the data sets that are being processed. Because of this, a modern computer system could be consuming power at its lower limit, and, milliseconds later, it could be operating at the highest limit of its design range.

Most modern computer systems allow configuration of power usage profiles. Manufacturers set the maximum power setting. They also provide standard settings for different conditions that can be modified by the end users to match their usage patterns. This entails turning off unused portions of the system, reducing the clock rate, or inserting wait states that allow for the system's power envelope to be modified. In the case of portable computer systems, these modifications usually occur upon transitions between battery charge and discharge states. Modern data centers can use hundreds to thousands of computer systems. Power usage varies with application loads. The loads vary over a range of time scales. The result is that very few of the processors or computers run at maximum power at the same time. Informal estimates indicate that less than 20% of the systems will peak at maximum power usage at any given instance. What is needed is a better means of controlling system power usage to more effectively manage and utilize computer resources while lessening power costs.

Existing power-management controls for computer systems fall into two categories. Each uses the same set of control functions that are built into the processor, chipsets and other components.

The first set of existing power management controls are system settings that are usually managed through an interface. Advanced Configuration and Power Interface (ACPI) is the most common example of this sort of management interface. The manufacturer provides the power setting configurations and default settings. The end users of the computer systems may then modify the settings. The settings are based upon the creation of a maximum-power envelope for the selected usage model. For example, in a laptop there could be different settings depending upon the type of battery and its present state of charge. When an event occurs, an interrupt is generated and the change is evaluated. Depending upon the change, a new power profile may be set for the various components. It should be noted that these settings may not actually change the current power-usage model because the settings are based upon potential power usage, not actual ones. This is because the power consumption of today's semiconductor devices is dependent, not only upon these settings, but also upon instantaneous usage by the software. The same issues relate to all aspects of ACPI, whether the power monitoring of a computer system, a building, a region, or the entire electrical grid. What is needed is a means to change the power-usage verses performance model of computers to one based on actual power usage that includes the effects of software interaction.

The second set of existing power-management controls are the failsafe temperature controls built into semiconductor components. In these controls, hardware circuits monitor the temperature of the device, and, if the temperature approaches an unsafe condition, the power usage of the device is reduced. Intel's Speed Step™ is an example of the use of auto detection and microprocessor power-reduction techniques to turn off sections of functionality to conserve power. As in similar cases, while this affects the power usage of the device, the real purpose of the control is to keep temperatures from rising to a level where damage may occur. What is needed is a means to provide maximum performance, but keep computer and device power consumption from exceeding the currently available power that may be supplied given the instantaneous usage model of the computer or device.

In neither of these two sets of power management cases is the instantaneous power consumption of the system or its devices used to determine whether controls should be implemented. Temperature and the total power envelope may be factors, but current systems do not address the question of actively monitoring power consumption for the purpose of maximizing performance while minimizing power consumption levels. Electrical power is a limited resource. For large computer centers, it represents substantial costs. Current state-of-the art power consumption management technology fails to recognize that the availability and cost of power are critical elements in the operation of large-scale microprocessor based computer and power management systems at increased cost and limitation. Accordingly there is a strong need in the art for an ability to continuously monitor and adjust power consumption of a system or system(s) or their devices to maximize performance while at the same time minimizing power consumption levels.

### SUMMARY OF THE INVENTION

There is a need for the following embodiments of the invention. Of course, the invention is not limited to these embodiments.

In light of the above described problems and limitations with regard to the current structures and methods of operating computer thermal and power envelope control systems and conventional power consumption management systems (hereinafter, computer systems), it is an object of the present invention to provide means and methods to continuously monitor and adjust the real time power consumption of such systems using the confines of two programmable-power consumption levels, termed the “upper” and “lower” trip points in order to optimize power consumption levels so as to reduce power usage and to control power costs while maximizing performance.

An additional object of the invention is to provide the means whereby, upon boot of the computer system, the lower trip point is set at a zero power level and the upper is set at the lowest possible functional setting whereby it may, when the operating system rises to that functional level, be allowed to determine the currently appropriate power settings so as to then permit and ensure that the power-sensor circuits may be programmed to the appropriate levels.

It is a further object of this invention to monitor power consumption so that when the upper or lower trip points are reached the power level can be rapidly reset to reduce or increase potential system power consumption so as to run at the most appropriate power state.

It is an object of the invention to accomplish the monitoring and adjustment of the power consumption of the computer system through the use of two circuits, or by a single circuit that combine the two functions. Interrupts are triggered based on pre-determined power levels relative to actual power levels which advise programmable power adjustment through use of the computer's software system, either by the operating system or the system boot firmware.

It is also an object of the invention to be simple and compact enough in its circuitry so as to accomplish its objectives within the confines of a single, small, integrated circuit capable of being implemented within a CPU or associated micro circuitry.

A further object of the invention is to use it to retrofit existing computer systems via a power monitoring circuit in a power cord, a means to communicate the power status and requirements, and software to set power consumption levels.

Yet another object of the invention is its use when multiple computer systems share a common power supply utilizing a dynamic slot technique to allocate and share power.

Yet another object of the invention is in allocating power consumption “cookies” These “cookies” may be allocated to systems on a fixed, or as needed basis to arbitrate for more power.

An additional object of the invention is its use with multiple computer systems that do not share a common power supply but where there is a need to control the overall power consumption of the physical location or multiple physical locations.

According to an embodiment of the invention, a method comprises: measuring power consumption of a variable power requirement load by a power monitor; and controlling power requirement of the variable power requirement load by sending from the power monitor i) a down_power interrupt to enable one at a time a plurality of power saving features and ii) an up_power interrupt to disable one at a time a plurality of power saving features, wherein a) the down_power interrupt is generated by the power monitor in response to a high_trip interrupt that is generated in response to measured power consumption being greater than or equal to an upper threshold, unless there has been a previous enablement of all of the plurality of power saving features and b) the up_power interrupt is generated by the power monitors in response to a low_trip interrupt that is generated in response to measured power consumption being less than or equal to a lower threshold, unless a mask_up bit has been written by a previous disablement of all of the plurality of power saving features.

According to another embodiment of the invention, a method comprises: measuring power consumption of each of a plurality of variable power requirement loads by an associated one of the plurality of power monitors; and controlling power requirements of each of the plurality of variable power requirement loads by sending from the associated one of the plurality of power monitors i) a down_power interrupt to enable one at a time a plurality of power saving features and ii) an up_power interrupt to disable one at a time a plurality of power saving features, wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

According to another embodiment of the invention, a system comprises: a variable power requirement load; and a power monitor coupled to the variable power requirement load, wherein a power consumption of the variable power requirement load is measured by the power monitor, wherein power requirement of the variable power requirement load is controlled by sending from the power monitor i) a down_power interrupt to enable one at a time a plurality of power saving features and ii) an up_power interrupt to disable one at a time a plurality of power saving features, wherein a) the down_power interrupt is generated by the power monitor in response to a high_trip interrupt that is generated in response to measured power consumption being greater than or equal to an upper threshold, unless there has been a previous enablement of all of the plurality of power saving features and b) the up_power interrupt is generated by the power monitors in response to a low_trip interrupt that is generated in response to measured power consumption being less than or equal to a lower threshold, unless a mask_up bit has been written by a previous disablement of all of the plurality of power saving features.

According to another embodiment of the invention, a system comprises: a plurality of variable power requirement loads; a plurality of power monitors coupled to the plurality of variable power requirement loads; a power bus electrically coupled to the plurality of power monitors; and a plurality of power supplies electrically coupled to the power bus, wherein a power consumption of each of the plurality of variable power requirement loads is measured by an associated one of the plurality of power monitors, wherein power requirements of each of the plurality of variable power requirement loads is controlled by sending from the associated one of the plurality of power monitors i) a down_power interrupt to enable one at a time a plurality of power saving features and ii) an up_power interrupt to disable one at a time a plurality of power saving features, wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

According to another embodiment of the invention, a kit-of-parts comprises: a plurality of power monitors; and a machine readable medium, including a program for: measuring power consumption of each of a plurality of variable power requirement loads by an associated one of the plurality of power monitors, controlling power requirements of each of the plurality of variable power requirement loads by sending from the associated one of the plurality of power monitors i) a down_power interrupt to enable one at a time a plurality of power saving features and ii) an up_power interrupt to disable one at a time a plurality of power saving features, wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 is a block diagram of a processing unit, representing an embodiment of the invention.

FIG. 2 is block diagram of the power supplies as connected to the processing units, representing an embodiment of the invention.

FIG. 3 is a circuit diagram of a power measurement and management unit, representing an embodiment of the invention.

FIG. 4 is a circuit diagram for the interrupt control logic, representing an embodiment of the invention.

FIG. 5 is a block diagram of pre-boot power routines, representing an embodiment of the invention.

FIG. 6 is a block diagram of an example of pre-allocated runtime change value use, representing an embodiment of the invention.

FIG. 7 is a block diagram of dynamic allocation of power consumption levels, representing an embodiment of the invention.

FIG. 8 is a schematic block diagram of a system including a server that distributes power slots and power cookies, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The invention constitutes a continuously self-monitoring and self-adjusting electrical power consumption computer control system for the provision of maximum performance levels and the creation of optimal managerial efficiencies in computer and other systems. Its circuitry, mechanisms and methods operate upon a virtually instantaneous basis to provide the means for monitoring, modifying and controlling electrical power consumption. It permits the selection of maximum component performance levels while minimizing power consumption levels to best effect cost savings. The invention assesses the need, availability and consumption of power in view of varying component and ambient thermal factors during the operation of the system, and in light of virtually instantaneous shifts in power demands caused by constant fluctuations in the number of programs in use, and in data set sizes and their relative computational complexities. The inventions mechanisms set variable upper and lower trip level limits for use in the calculation of optimal operational thresholds and for their execution. It may be used in the control of single or combined computer system groups. It is particularly suitable for use in single or multiple microchip configurations with direct analog and digital inputs and outputs, and in high performance broadband computers with complex multiple operational nodes. Can be used in other systems similarly.

The invention can include a single computer with an integrated (onboard) circuit and associated software that continuously monitors its power consumption and adjusts its hardware configuration to maintain its power consumption within a given range.

The invention can include an external device that is inserted inline with the power feed of an existing computer system and having a method of interrupting the computer system to allow software installed on said system to adjust the hardware configuration in order to maintain the power consumption within a definable range.

The invention can include multiple computer systems sharing a common power supply or supplies such that the group of systems have a total power consumption range and that each computer system is allocated a portion of that range allowing for smaller power supply than would be required if the maximum power required to run all systems had been configured.

The invention can include the foregoing multiple computer systems combined with a low latency interconnect to allow for the dynamic sizing of the individual computer systems power consumption to take into account the current power usage by other systems sharing the power supply. In this manner a system might give up a portion of its “power budget” that it is not using to another system that has a need for additional power budget at a given point in time.

The invention can include the foregoing multiple computer systems combined with coordinating over a local or wide area network such that the maximum power consumption for a building, campus or distributed group of sites could be regulated. i.e. Remote setting of the limits. This can allow for the automatic detection of loss of power to the building, room or campus (feed failure) setting the total power consumption lower until such time as the power feed is restored. This can allow for a preemptive power consumption adjustment in order to avoid a potential brown out situation.

The invention can include the foregoing multiple computer systems combined with creating “classes” of power usage with computers either dynamically or statically (by operator) assigned to the classes. Method would allow for computers to be moved from one class to another as long as total power consumption would never be allocated to greater than the power available to the system.

The invention can include the foregoing multiple computer systems combined with the capability that when a failure of one or more of the multiple shared power supplies occurs the total power consumption for the system is reduced to what can currently be supplied by the remaining shared power supplies.

The invention can include a computer system supporting multiple configurations where some additive components (I/O Cards, Disk drives) add variable amount of power consumption that can be adjusted in a dynamic manner and/or fixed amount(s) of power consumption that can not be adjusted in a dynamic manner. The configurable (additive) components can have their power consumption monitored and subtracted from the total power available to the computer system. This can be in the context of a multi-computer system sharing a common power supply and/or with the variable portion located in another chassis and communicating over a local or wide area net. Example Computer system attached to a disk subsystem where the disk subsystem is power monitored and its consumption depends upon the number of disk drives currently active in the system.

The invention can include the continuous self-monitoring and self-adjusting of the electrical power consumption for computer and other systems to allow for the maximum performance of said system by the creation of optimal managerial efficiencies in computer systems through the use of circuitry, mechanisms and methods that operate upon an instantaneous basis to provide the means for monitoring, modifying and controlling electrical power consumption.

The invention can include use of an external monitoring device connected inline to a computer systems external power supply and to an I/O port on the computer and other systems to allow a data center, building or campus wide monitor to set maximum overall power usage for the structure while maintaining optimal performance over the range of control.

The invention can include dynamically allocating power using a high speed low latency interconnect in such a manner to allow multiple processing units to share a power supply with a total power output less than the non-monitored maximum consumption level for the computer systems by dynamically assigning computer units to pre-set power ranges. Moving computer or other units from one power range to another based upon but not limited to such factors as current throughput requirements, instantaneously power consumption and the computer's relative application priority.

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

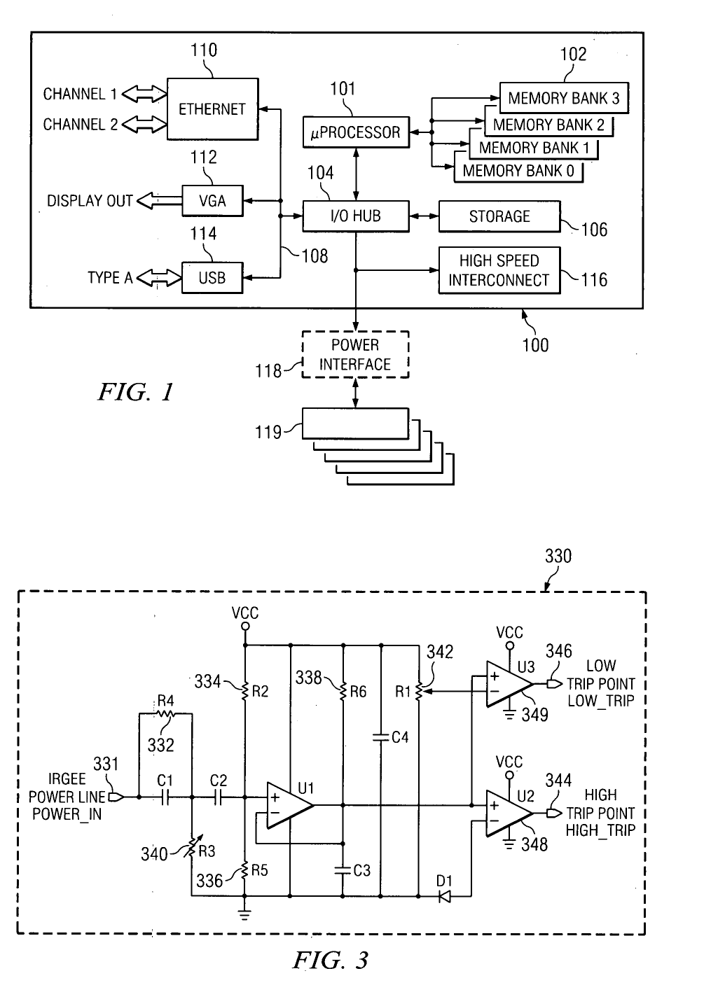

FIG. 1 is a block diagram of a preferred embodiment. This preferred embodiment will be explained with reference to FIGS. 1-5. This preferred embodiment is a computer system with 32 processor modules 100 each consisting of a processor 101, a memory 102 and an input/output (I/O) hub 104. The I/O hub 104 can be connected to i) storage 106, such as a disk drive, and ii) networking capabilities 108 which can support Ethernet type connections 110, display connections 112, and USB type connections 114. The I/O Hub 104 can also interface to a high-speed, low-latency interconnect 116.

These 32 processor modules 100 (elements) are connected by a power interface 118 to a common set of power supplies 119, which facilitates leveling power usage within the computer system. The power supplies 119 for the system are configured to provide redundant power for any particular usage model. There may be multiple computer systems connected to multiple power supplies on a shared power bus. Use of the invention is not limited to this embodiment and would be applicable to most, if not all components, computer systems, or any system or systems with variable power requirements and limited power resources

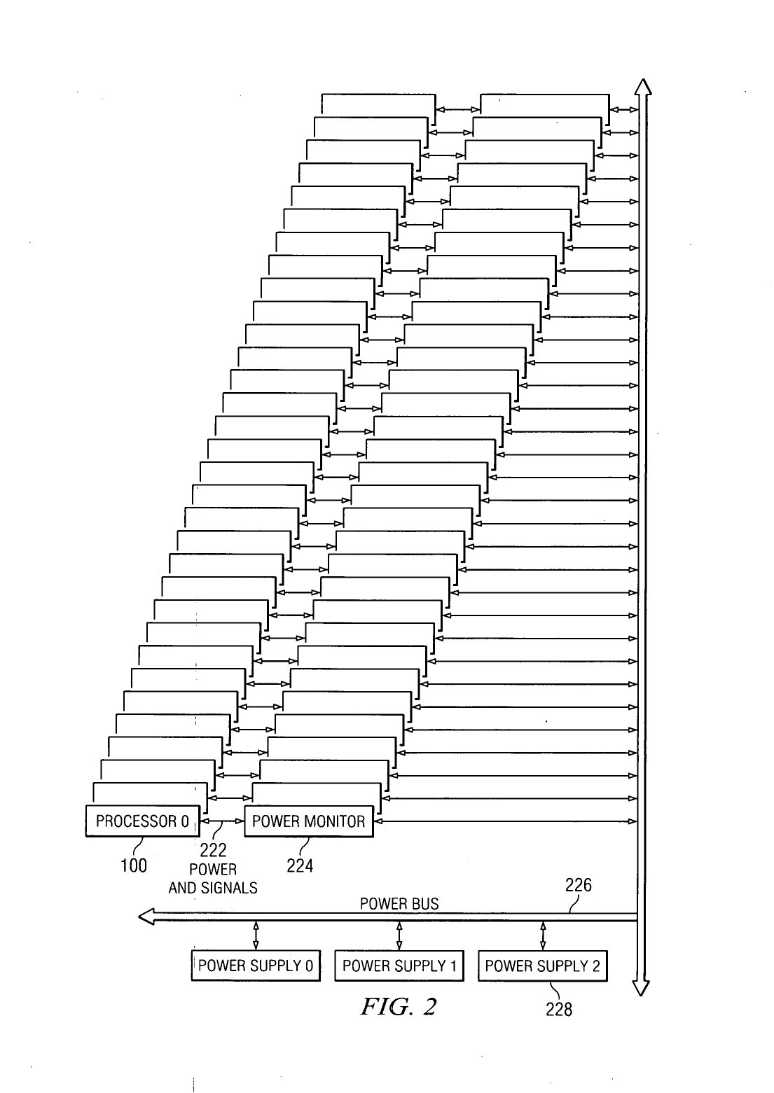

FIG. 2 is a block diagram of three power supplies 228 as connected to thirty two processing modules (units) 100. Each processing module (unit) 100 is connected to a power monitor 224. Power and power level signals 222 are able to be transferred between each power monitor 224 its associated processor 100. Each power monitor 224 is connected to the power bus 226, which is also attached to each of the n power supplies 228.

In the simplest implementation of this invention, the power-consumption levels are assigned in a fixed allocation and stored in the processors' non-volatile boot memory. On boot, this pre-assigned value is loaded into a power measurement and management circuit, such as the circuit 330 shown in FIG. 3. The overall responsibility for assigning power levels to the computer systems (and/or to the processor modules) can be an outside entity. This entity may or may not reside on one of the computer systems (and/or processor modules) being power managed. The assigned power levels can be changed, either by issuing a system (and/or processor) level command or by system-management (and/or processor modules) software doing the same update.

FIG. 3 is a circuit diagram for power measurement and management. It shows how to monitor the total power entering the computer system (and/or the processor module) and respond at preprogrammed levels. The circuit is across the input power line 331 in order to measure the power. Selection of the resistors 332, 334, 336 and 338 must be sized to the overall power requirements of the computer system (and/or the processor module). Once the overall power envelope has been established then the programmable resistor 340 and programmable tap resister 342 are electronically set to the high 344 and low 346 trip points.

This circuit 330 uses op amps 348/349 and the two programmable resistors 340/341 to set current thresholds that when exceeded high or low will cause the op amps 348/349 controlling HIGH_TRIP 344 or LOW_TRIP 346 respectively, to flow current. The circuit diagram does not show either the design of the control logic for the programmable resistors or the logic for converting the output signals into system interrupts, as it will be understood that these may readily be completed using standard techniques designed to suit each particular application by those skilled-in-the-art.

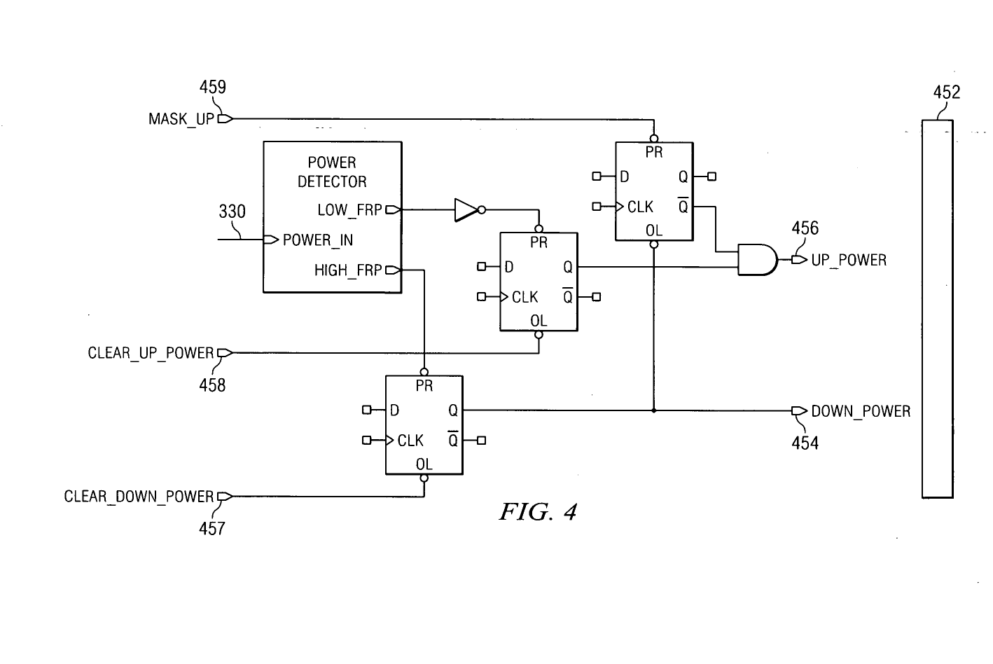

FIG. 4 is a circuit diagram for the interrupt control logic. It presents a block diagram of the interrupt circuit used to generate the proper interrupts to the computer system (and/or processor module) and allow the software to indicate completed tasks. This circuit incorporates some simple logic gates to ensure that the power event will be both detected and held in order for the event to be evaluated and then cleared by the responding software. This circuit takes the information generated by the FIG. 3 power monitor circuit 330 and implements the logic to enable the automatic control of the power settings 452 in a machine (or a computer system and/or a processor module).

Part of the response by the software is to allocate or de-allocate power resources when the corresponding interrupt occurs, and reset the interrupt generator. MASK_UP 459, CLEAR_UP_POWER 458 and CLEAR_DOWN_POWER 457 are used by the software to reset the latches so that the same power event is not repeatedly responded to. Upon a FIG. 3 LOW_TRIP 346 interrupt, the software sets the power controls and uses the CLEAR_UP_POWER 458 to clear the interrupt on the UP_POWER 456 output. The FIG. 3 HIGH_TRIP 344 interrupt is used to indicate a situation where the power controls will be used to reduce the power consumption of the system (and/or processor module). In this case the software sets a control that reduces the power consumption and clears the interrupt, or DOWN_POWER 454 interrupt, by setting the CLEAR_DOWN_POWER 457 bit.

Continuing with FIG. 4, there are two special cases that the software must deal with when the interrupts UP_POWER 456 interrupt and DOWN_POWER 454 interrupt occur. The first is when the software receives an UP_POWER 456 interrupt but there are no more controls to increase the performance of the computer system. In this case you do not wish to have the computer to continue to receive interrupts when there is nothing that can be done about it. The software after determining that there are no more controls to invoke will set the MASK_UP 459 bit so that no more interrupts will be received thereby asking to increase the performance. When the next DOWN_POWER 454 interrupt is received by the software the MASK_UP bit 459 will cleared.

The other case occurs when a DOWN_POWER 454 interrupt occurs and the software determines that there are no other controls to reduce the power consumption. In this case the issue needs to be raised to a higher-level piece of software to determine the protocol for handling this situation. Example policy decisions that could be returned include but are not limited to: a shut down of the node, acquiring power budget from another node or bringing an additional power supply online to increase the total budget.

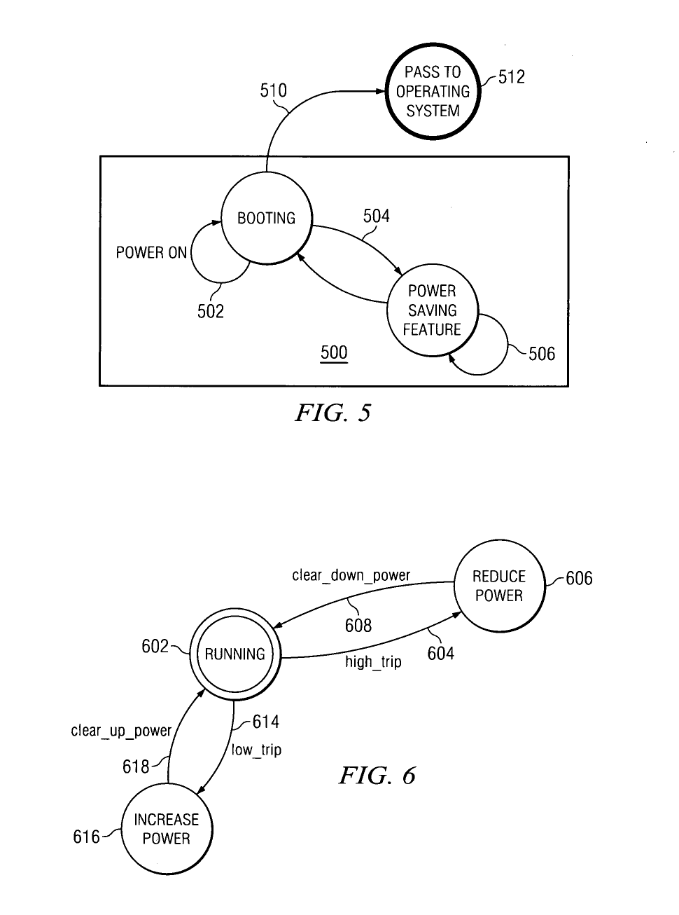

FIG. 5 is a block diagram of the pre-boot power routines. The system (and/or processor module) is initialized to the lowest power setting possible and during the pre-boot process 500, the computer system (and/or processor module) looks into its non-volatile memory for the pre-set power level for the system. As power comes on 502 and system (and/or module) functionality becomes available, the system (and/or module) sets the appropriate power control settings based on the pre-set power level.

If during this process the power usage exceeds the preset power usage limit, a FIG. 4 DOWN_POWER 454 interrupt is triggered. That interrupt causes the pre-boot firmware to enable 504 one of the power-saving features 506, which may include altering clock frequency, turning off caches, turning off parts of the chipset, and inserting wait states. This power saving process 506 continues until the power limit is not being exceeded. Once the pre-boot process has completed 510, control is passed 512 to the operating system.

FIG. 6 is a block diagram of an example of pre-allocated runtime change value use. It illustrates the system (and/or module) use during runtime 602 of pre-allocated power level change options. Here, all of the computer systems (and/or processor modules) have had their values set by either manual intervention or by a system (and/or module) management function. When a HIGH_TRIP 604 interrupt occurs, it causes a DOWN_POWER reaction whose function it is to invoke a reduce power feature 606. This reduction in power continues until the power limit is no longer exceeded. At that point a CLEAR_DOWN_POWER 608 trigger process is initiated. When a LOW_TRIP 614 interrupt occurs, it causes an UP_POWER reaction whose function it is to invoke an increase power 616 feature. This increase in power continues until the power floor is satisfied. At that point a CLEAR_UP_POWER 618 trigger process is initiated.

### Alternate Embodiments

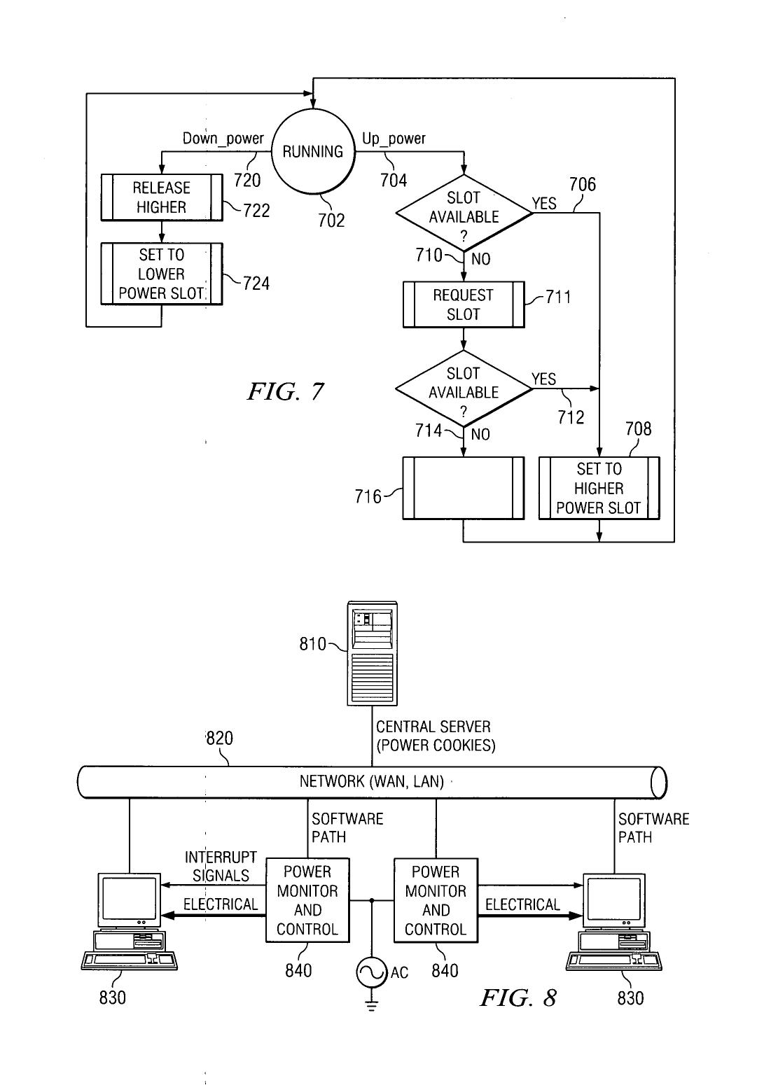

A second implementation of the invention involves a dynamic allocation of power consumption levels such as shown in FIG. 7. In this case multiple computer systems (and/or processor modules) share a common power supply. A number of “slots” of high power, medium power and low power slots are allocated. This is done by using a distributed locking system, which is software that allows for mutual exclusion across multiple computer systems (and/or processor modules) and could be implemented using one of the many available cluster-lock managers

The number of logical slots is based upon the number of physical connections available from the common power supply. These logical slots can be reconfigured either by commands or system (and/or module) management software as long as the total power does not exceed the maximum power that is deemed to be capable of being provided by the common power supplies. If a computer system (and/or processor module) starts to require more power, the system using the lock manager checks to see if there is a higher-power slot available. If there is, then using the lock manager, the system (and/or processor module) is assigned the higher-power slot. If no slot is available, power consumption is reduced in the same manner as in the pre-allocated method.

Continuing with FIG. 7, in this case, a distributed-lock manager is implemented using either the high-speed interconnect 116 in FIG. 1, or the Ethernet interface 110 shown in the same drawing. A systems-management component presets the number of computer systems (and/or processor modules) that are allowed to run at each power level. All systems (and/or modules) boot into the lowest power state. Those systems (and/or modules) using the cluster-lock manager, which ensures that the maximum power consumption level is not exceeded, increase their power settings consuming the highest power slot available. If, after a fixed interval, the indicated systems (and/or modules) do not use the additional power, they set themselves back to the lower-power level and release one of the high-power slots. This process continues until either i) all high-power slots are used or ii) all of the computer systems (and/or processor modules) have tried the highest power level and at least some of them have determined that there is not a present need for the highest power level.

While the computer systems (and/or processor modules) are running 702, if one of them reaches a condition where throughput becomes limited by system performance while the system (and/or module) is not currently at the highest power setting, that system (and/or module), using the cluster-lock manager, attempts to increase that system's (and/or module's) power 704. If a slot is available 706 the system (and/or module) acquires a high-power slot 708 and changes its power settings to that of high power. If no high power slots are available 710, a request is sent 711 to those systems (and/or modules) using the high power slots, requesting a release of a high-power slot. In this case an operating system process will inject the FIG. 4 UP_POWER 456 interrupt condition into the software.

If one of these systems (and/or modules) is currently below the drop-down, power-consumption level, it sets itself to the lower-power setting and releases a high-power slot to the requesting computer system (and/or processing module) 712. If none of the current high power users are in a state that allows a release of a high-power status 714, then the request fails and the requesting system (and/or module) then sets a delay 716 and, if it still needs the high power state after the delay, it sends another request, repeating this delay-and-request process until either the request is granted or the need for the high power state has passed. If a system (and/or module) is in the running state 702 for a fixed interval without using the additional power 720, it releases one of the high-power slots 722 and sets themselves back to the lower-power level 724.

A third implementation of the invention involves operating a dynamic allocation system with power groups, using a combination of the fixed and dynamic allocation methods. In this case there is a list of computer systems that have priority for the high-power slots. The initial boot process allocates (using the cluster-lock manager) the high-power slots to these high priority systems and execution continues running as normal. If, during the normal operation of the systems, one of the lower-priority systems needs additional power, it can make a request through the cluster-lock manager for the use of one of the high priority systems not needing its logical high power slot. Therefore, multiple group types with different power expectations and characteristics can be managed. For instance, one group may receive the highest power at all times; another group may get highest-power allocation, but will release to another computer system if it is not being used; and yet another group that may be the first to be placed in lower power state if any other systems requests a higher power setting. This list of groups could be extended to include groups that all move from one power state to another at the same time.

Another implementation of the invention has the advantage of permitting the implementation of its various versions when non-shared power supplies are used to manage power resources in a building, on a campus, in cities or in even larger regions. Examples of this would be where power companies ask for voluntary reductions. Another would be when a location has gone onto a UPS (Uninterruptible Power Supply) state, requiring the use of batteries or other local power generation, and it is desirable to limit the location's current power usage in order to sustain the time that the UPS can provide power to the structure or room. The application of this implementation applies to any device with multiple power consumption levels that can communicate to a network.

Such an implementation could involve the use of an agent resident on the managed device, be it a computer, networking device, machine tool or anything else with adjustable power consumption levels. There would be a pre-determined power envelope for the area that could involve “power cookies” that would add up to the total power usage for the monitored site. The “power cookies” would be assigned to the various managed devices until the power consumption level was reached. These cookies could be moved from device to device and reallocated over time allowing the various devices to consume higher power levels as long as the total consumption of power cookies did not exceed the pre-assigned limits. This could function over a high speed cluster interconnect, Local Area Network (LAN), cellular network, Wide Area Network (WAN) or even the Internet. This system of implementation could be implanted in a hierarchal manner where sub-sites would be given a total power envelope and then assign and monitor their local power cookies. In turn, an overall management tool would manage a “meta power cookie” for the site.

Referring to FIG. 8, a central server 810 controlling the disposition of power cookies is coupled to a network 820. A plurality of computer systems (and/or processor modules) 830 are coupled to the network 820. This coupling between the plurality of systems (and/or modules) 830 and the network 820 includes a software path. Each of the plurality of systems (and/or modules) 830 are also coupled to the network 820 via a power monitor and control 840. The coupling between the power monitor and control 840 and the network 820 includes a software path. Each of the plurality of systems (and/or modules) 830 is electrically powered via its power monitor and control 840. Each of the plurality of systems (and/or modules) 830 receives interrupt signals from its power monitor and control 840.

If devices are equipped with power management circuits based on embodiments of the invention, their power consumption could be monitored on a dynamic basis, causing the monitored systems to have lower performance only when their operation exceeded the limits of their current power cookie. However, if they attempted to exceed their power cookie limits, they could request a high power cookie and have one assigned, if available, using the methods described above.

Even without a power monitor circuit this method could still be implemented. However, in this case the method would set the device so that it could not exceed the allocated power cookie. Since there would then be no way of monitoring the power usage, other indicators would be needed to permit dynamic operations. For example, a thermostat could request a higher power cookie if a temperature range was exceeded. In the case of a computer system, the higher power cookie could be requested if system resources fell below a pre-determined level.

An additional embodiment of the invention is to permit its use in retrofitting existing computer systems through the use of a module including two elements: the first being a unit that would be inline with the power cord to the computer system and contain the power monitoring circuit with a method of two way communication to the existing computer system, such as through a Universal Serial Bus, a Firewire—IEEE 1394 standard, a serial port or an add in card; and the second being software that would set the initial power consumption levels while monitoring the power trip points and implementing the appropriate power settings.

A further embodiment of the invention is its adaptation for use in combination with both normal and high speed computer interconnects, like Lightfleet Corporation's Optical Fan-Out and Broadcast Interconnect, described in its United States Patent Application Number 20040156640, which would permit use of the invention over local area networks, or even wide area networks depending upon the size of the areas to be managed as a group wherein the interconnect was responsible for monitoring and controlling power allocations across local or even entire sections of the nation's electrical grid and the invention's mechanisms were used to report and to assist as a part in the calculation of local, regional and national grid overload and electrical usage reduction measures.

Another embodiment of the invention to present the benefits of the framework of its mechanisms and methodology for use in applications undertaken in conjunction with Xyron Corporation's Zero Overhead Computer Interrupts with Task Switching, U.S. Pat. No. 5,987,601, together with its associated European and international patents and pending applications, with that invention's unique, zero overhead interrupt and task change mechanisms for use in microprocessor computer architectures for detecting interrupts in the background and then performing complete state saving and restoring operations between one processor cycle and the next without software intervention. The combined use of the present invention either in association with Xyron's technology or as actually incorporated within its microprocessor implementation provides the capability to monitor, calculate and pre-calculate the need for and to permit power level changes in single cycle nanosecond operations in ordinary use. Similarly, the combination is of utility when used in association with massively parallel adaptive pattern recognition algorithms capable of processing billions of permutations and combinations when implemented in such high performance computers as Lightfleet Corporation's Optical Fan-Out and Broadcast Interconnect, described in United States Patent application 20040156640. The results of the adaptive pattern recognition studies will permit the calculation and setting of optimal computer system power and thermal performance operational levels at maximum speeds across wide ranges of uses, while serving to prevent system overload failures otherwise arising in the course of meeting sudden requirements for powering_down system function levels.

Yet another embodiment of the invention is to gain advantages from its use in association with or by incorporation within Xyron Corporation's High Speed Analog to Digital Converter, U.S. Pat. No. 6,445,326 together with its associated European Patent Application Number 01950393.7. The combined use of the two inventions permits direct analog to digital inputs of thermal and electrical information in a single microcircuit computer system without unacceptable interference. It permits continuous, direct, optimal, adjustable power and thermal modifications and control in computer system operations taking advantage of Xyron's oscillator counting mechanisms at their femtosecond speeds.

In addition to its use with other more conventional digital to analog conversion circuits, it is yet again another embodiment of the invention to gain the benefits it affords in its use in association with or by incorporation within Xyron Corporation's Digital to Analog Converter, U.S. patent application Ser. No. 10/477,684 and its associated international applications. The combined use of the two inventions will permit high speed conversion of digital to analog outputs in conjunction with computer systems seeking continuous, direct, optimal, adjustable power and thermal modifications and control in computer system operations and calculations.

### Advantages

It is a benefit of the invention that it allows a computer system to run at full speed until the execution environment causes it to exceed a configured upper power limit. Only at this time is the performance level reduced. When power needs fall so that the lower trip point is reached, the system return to whatever full performance setting is determined optimal under the then existing operational circumstances. This is of advantage to all computers, both those running on standard wall power or high power electrical outlets or on batteries such as in laptop computer systems. Current methods reduce the performance in anticipation of possible power consumption even when the actual usage would never exceed the required power limit because of the tasks assigned to the computer system.

It is of significant value that the invention allows for a group of systems to share a power supply that is configured, not for the maximum power usage of each computer system, but for the group maximum power usage. This results in a much smaller overall power envelope for the given computer systems.

The invention holds additional merit in that it allows Information Technology and Building Management to set an upper limit on building power consumption for the computer systems without affecting the performance of the systems unless they try to exceed the maximum power allocation arising from application needs. It also readily allows for management decisions on which applications should have priority at the allocated power level, for example, for embedded applications.

The invention's principal values are its contribution to the reduction in costs for the operation of computer systems, an increase in reliability of the computer system, its enhancement of computer performances, its benefits in adding to computer system managerial control, and its overload detection and workload leveling aspects with their protective contributions to protection against computer system failures with their consequent associated computational, commercial and industrial costs, losses and damages.

### DEFINITIONS

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
measuring power consumption of a variable power requirement load by a power monitor; and
controlling power requirement of the variable power requirement load by sending from the power monitor i) a down_power interrupt to enable one at a time a plurality of power saving features and ii) an up_power interrupt to disable one at a time a plurality of power saving features,
wherein a) the down_power interrupt is generated by the power monitor in response to a high_trip interrupt that is generated in response to measured power consumption being greater than or equal to an upper threshold, unless there has been a previous enablement of all of the plurality of power saving features and b) the up_power interrupt is generated by the power monitors in response to a low_trip interrupt that is generated in response to measured power consumption being less than or equal to a lower threshold, unless a mask_up bit has been written by a previous disablement of all of the plurality of power saving features.

2. The method of claim 1, further comprising erasing the mask_up bit in response to a down_power interrupt.

3. The method of claim 1, further comprising generating an error interrupt in response to a high_trip interrupt when there has been a previous enablement of all of the plurality of power saving features.

4. A method, comprising:
measuring power consumption of each of a plurality of variable power requirement loads by an associated one of the plurality of power monitors; and
controlling power requirements of each of the plurality of variable power requirement loads by sending from the associated one of the plurality of power monitors i) a down_power interrupt to enable one at a time a plurality of power saving features and ii) an up_power interrupt to disable one at a time a plurality of power saving features,
wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

5. The method of claim 4, further comprising erasing the mask_up bit in response to a down_power interrupt.

6. The method of claim 4, further comprising generating an error interrupt in response to a high_trip interrupt when there has been a previous enablement of all of the plurality of power saving features.

7. The method of claim 4, further comprising distributing power slots to at least a subset of the plurality of power monitors.

8. The method of claim 4, further comprising distributing power cookies to at least a subset of the plurality of variable power requirement loads.

9. A computer program, comprising computer or machine readable program elements translatable for implementing the method of claim 1.

10. A machine readable medium, comprising a program for performing the method of claim 1.

11. A system, comprising:
a variable power requirement load; and
a power monitor coupled to the variable power requirement load,
wherein a power consumption of the variable power requirement load is measured by the power monitor,
wherein power requirement of the variable power requirement load is controlled by sending from the power monitor i) a down_power interrupt to enable one at a time a plurality of power saving features and ii) an up_power interrupt to disable one at a time a plurality of power saving features,
wherein a) the down_power interrupt is generated by the power monitor in response to a high_trip interrupt that is generated in response to measured power consumption being greater than or equal to an upper threshold, unless there has been a previous enablement of all of the plurality of power saving features and b) the up_power interrupt is generated by the power monitors in response to a low_trip interrupt that is generated in response to measured power consumption being less than or equal to a lower threshold, unless a mask_up bit has been written by a previous disablement of all of the plurality of power saving features.

12. The apparatus of claim 11, wherein the plurality of variable power requirement loads include a plurality of computer systems.

13. The apparatus of claim 11, wherein the plurality of variable power requirement loads include a plurality of processor modules.

14. The apparatus of claim 11, further comprising a server coupled to at least a subset of the plurality of power monitors and at least a subset of the plurality of variable power requirement loads, the server distributing power slots to at least the subset of the plurality of power monitors and power cookies to at least the subset of variable power requirement loads.

15. A system, comprising:
a plurality of variable power requirement loads;
a plurality of power monitors coupled to the plurality of variable power requirement loads;
a power bus electrically coupled to the plurality of power monitors; and
a plurality of power supplies electrically coupled to the power bus,
wherein a power consumption of each of the plurality of variable power requirement loads is measured by an associated one of the plurality of power monitors,
wherein power requirements of each of the plurality of variable power requirement loads is controlled by sending from the associated one of the plurality of power monitors i) a down_power interrupt to enable one at a time a plurality of power saving features and ii) an up_power interrupt to disable one at a time a plurality of power saving features,
wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

16. The apparatus of claim 15, wherein the plurality of variable power requirement loads include a plurality of computer systems.

17. The apparatus of claim 15, wherein the plurality of variable power requirement loads include a plurality of processor modules.

18. The apparatus of claim 15, further comprising a server coupled to at least a subset of the plurality of power monitors and at least a subset of the plurality of variable power requirement loads, the server distributing power slots to at least the subset of the plurality of power monitors and distributing power cookies to at least the subset of variable power requirement loads.

19. A kit-of-parts, comprising:
a plurality of power monitors; and
a machine readable medium, including a program for:
measuring power consumption of each of a plurality of variable power requirement loads by an associated one of the plurality of power monitors,
controlling power requirements of each of the plurality of variable power requirement loads by sending from the associated one of the plurality of power monitors i) a down_power interrupt to enable one at a time a plurality of power saving features and ii) an up_power interrupt to disable one at a time a plurality of power saving features,
wherein a) the down_power interrupt is generated by the associated one the plurality of power monitors in response to a high_trip interrupt that is generated in response to measured power consumption being greater than or equal to an upper threshold, unless there has been a previous enablement of all of the plurality of power saving features and b) the up_power interrupt is generated by the associated one the plurality of power monitors in response to a low_trip interrupt that is generated in response to measured power consumption being less than or equal to a lower threshold, unless a mask_up bit has been written by a previous disablement of all of the plurality of power saving features.

20. The kit-of-parts of claim 22, further comprising a server, the server adapted for distributing power slots to at least a subset of the plurality of power monitors and distributing power cookies to at least a subset of the plurality of variable power requirement loads.
